(19) United States
(12) Patent Application Publication
(10) Pub. No.: US 2006/0154025 A1
(43) Pub. Date: Jul. 13, 2006

(54) TENSIONING ELEMENT, ESPECIALLY LASHING STRAPS, OCTUPUSE STRAPS AND RECEIVING NETS

(75) Inventor: Ruedi Hess, Tegerfelden (CH)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MAMMUT TEC AG, Seon (CH)

(21) Appl. No.: 10/542,160

(22) PCT Filed: Jan. 13, 2004
(86) PCT No.: PCT/CH04/00008

§ 371 Date: Jul. 14, 2005

(30) Foreign Application Priority Data
Jan. 14, 2003 (CH) 050/03
Dec. 1, 2003 (CH) 204/03

(51) Int. Cl. B32B 3/10

(52) U.S. Cl. 428/131; 428/99; 428/100

(57) ABSTRACT

The invention relates to a securing element for fastening loads. Said element is configured as a rope, belt, strap or cord with openings arranged in a grid pattern, consisting of a combination of elastic, semi-elastic and non-elastic materials. The openings are designed to receive a fastening element and an additional identical or similar securing element can be looped through said openings. By attaching at least one fastening element, e.g. a hook, any length of securing element can be selected. When configured as a net, the securing element acts as a retaining net and can secure loads of any type. Natural and synthetic materials can be used individually or in combination to produce said element.

The invention relates to a tensioning element, especially a lashing strap, an octopus strap and a receiving net as claimed in claim 1.

There are presently and have been for several years tensioning elements, octopus straps, on the market, which often consists of an elastic, round or oval textile, cable-like material, with a core of elastic filaments, wrapped or braided with colored yarns. The requirements for these tensioning elements are given in the TUeV standard with a breaking strength of 540 N (55 kg) light, 685 N (70 kg) medium, 1225 N (125 kg) heavy, octopus straps (55 kg).

A steel or plastic hook is attached to the end of these cable-like tensioning elements which have been cut to length, such that the end is clinched and riveted, nailed down, sewn or cemented, and thus becomes twice as thick, and in this way the hook can no longer slip out of the cable-like, elastic tensioning element.

Plastic hooks are also partially injected directly onto the elastic cable-like element which has been cut to length. These ends each have an awkward thickness on the end, since the twisted steel or injected plastic hook termination is 2-3 times thicker than the elastic, round tensioning element. This is generally troublesome in the bracing of elastic elements for attachment of a volume to baggage racks of bicycles and motorized bicycles by securing the hook which has a great thickness.

Likewise the customer must buy the correct length since he otherwise always has tensioning elements which are too long or too short. This is generally associated with difficulties since the article to be attached repeatedly has a different size or a different volume.

Several tensioning elements must be sometimes used since the volume of the material to be transported is often too large for one or two tensioning elements. Then so-called octopus straps are produced which hold together several of the elastic tensioning elements in a plastic ring or a plastic part.

But here the disadvantage is that the volume to be transported is not composed of a uniform body, so that one side of the octopus strap is too long and the other is too short.

Baggage nets of knit, double-ribbed, plaited or twisted cables and strings which however are generally not elastic and therefore cannot be adapted to the volume are known.

They therefore have the disadvantage that they must generally be combined with additional elastic tensioning elements in order to hold the volume of the transported item. Likewise the tear resistance of these nets is rather low, so that they quickly tear under a load.

U.S. Pat. No. 5,673,464 discloses a tensioning element [TN: tie-down strap in the U.S. patent] which has a main body which is elastic between two ends, with a plurality of openings. These openings stretch linearly between the two ends so that a second main body can be pulled through the stretched openings.

The disadvantage is that this tensioning element has two defined ends with one hook attached to each of them and thus always has a certain length, the hooks always being fixed on the ends. The main body consists of two parallel sides which form an opening for the second main body only under tensile stress. The second identical main body can only be pulled through the first main body when the latter is stretched and this first main body holds the second main body in position when it is relieved.

U.S. Pat. No. 3,913,178 discloses a tensioning strap which has a plurality of openings, in each of these openings a tongue being attached so that the tensioning belt can be looped back through one of these openings and in this way fixed or clamped at a certain location.

The disadvantage is that this strap in the openings has small tongues so that they have a clamping effect when these same elements are looped back. The strap is therefore designed such that it is clamped in itself instead of a buckle. In this way no hooks are possible, nor are several elements as a combination. Likewise the tensile force is limited to the clamping strength of the tongues.

Moreover not just any hooks can be used for attachment.

The object of this invention is to propose a tensioning element in which the disadvantages with respect to the required length are eliminated.

As claimed in the invention this object is achieved with a tensioning element according to the wording of claim 1 by an elastic, cable-like tensioning element being suggested such that it is repeatedly divided in two in a defined grid and is available as roll material.

The invention is detailed below using the drawings.

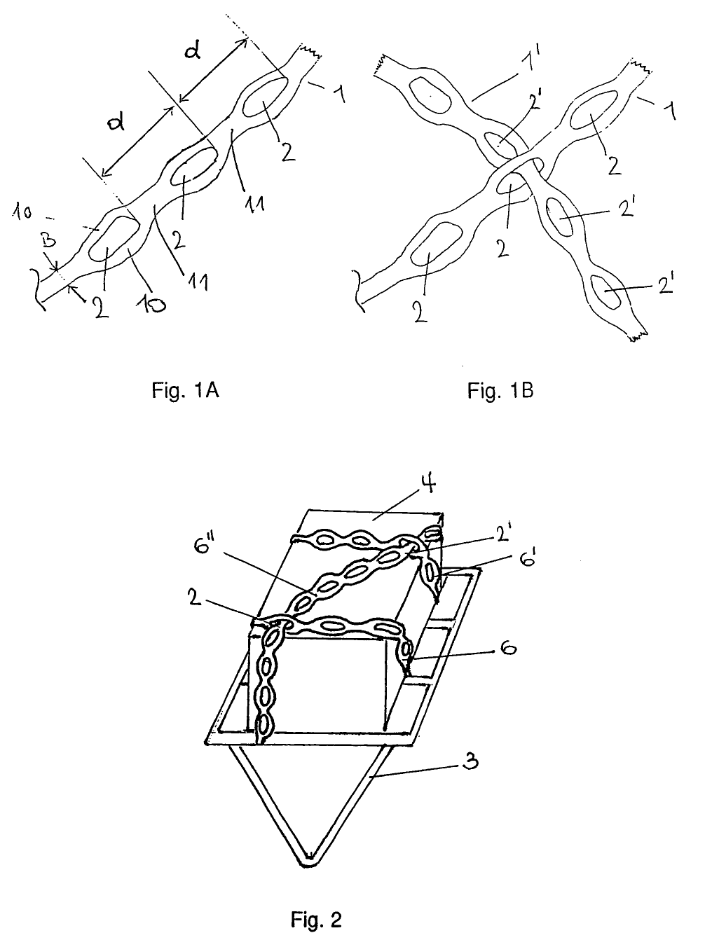

FIG. 1A shows a view of the tensioning element as claimed in the invention

FIG. 1B shows a view of the tensioning element as claimed in the invention with a second tensioning element looped through

FIG. 2 shows a tensioning element as an octopus strap for light loads

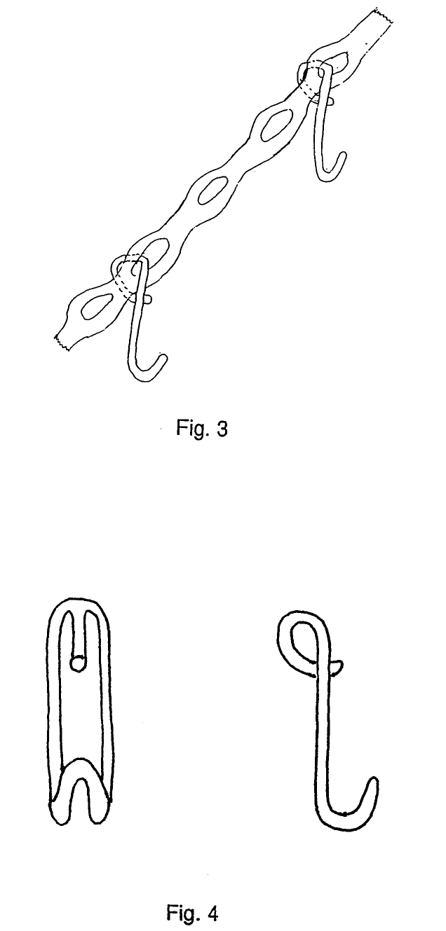

FIG. 3 shows a first embodiment of a tensioning element with two attached hooks

FIG. 4 shows a hook in a front view and a side view

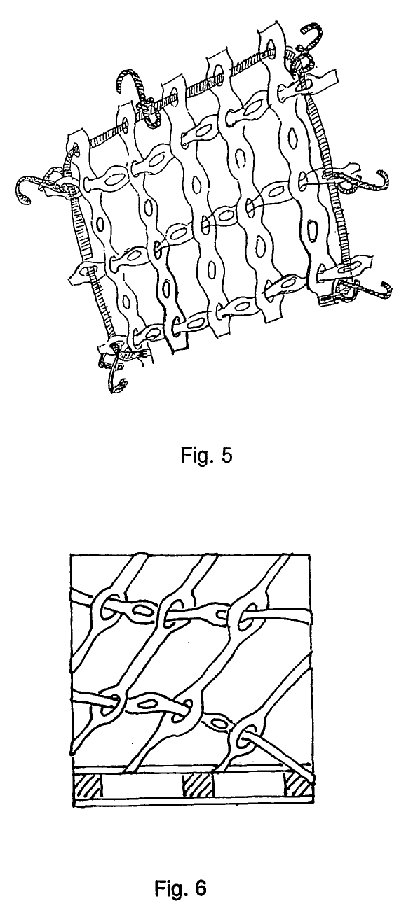

FIG. 5 shows a second embodiment of several tensioning elements as a baggage net for heavy loads

FIG. 6 shows a third embodiment of several tensioning elements as cargo retaining net

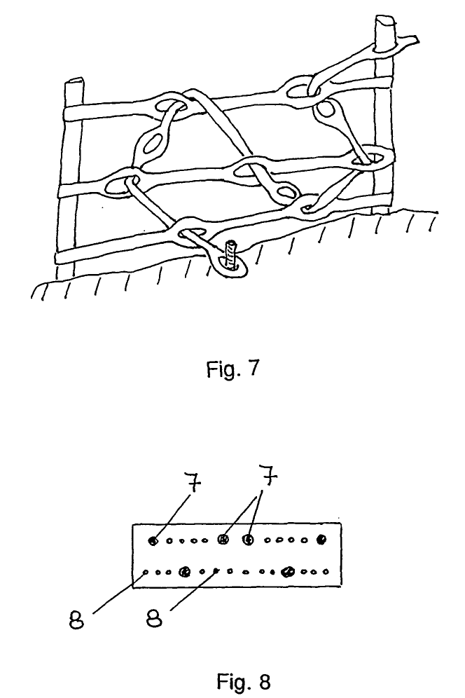

FIG. 7 shows a fourth embodiment of several tensioning elements as a shock-absorbing net

FIG. 8 shows a cross section of a tensioning element with reinforcement of stranded steel

FIG. 1A shows a view of the tensioning element as claimed in the invention. A cable-like, belt-like, strap-like or string-like product 1, hereinafter called a tensioning element, has a plurality of openings 2 which are arranged in the manner of a grid. The grid-like execution yields a grid distance d which is defined from one opening edge to the next. The grid distance is generally uniform over the entire tensioning element; but this is in no way essential. It can be for example alternating, i.e. a smaller one follows a larger one, or in the extreme case, completely arbitrary. This can be of interest in conjunction with different openings, as will be explained below.

The openings 2 have side elements 10 and transverse elements 11, the side elements consisting of an elastic and/or semielastic material and the transverse elements consisting of an inelastic and/or semielastic material. The openings 2 lead to division of the tensioning element 1 into two parts. Generally they have a uniform dimension, but this is in no way essential. Rather the functionality can be greatly increased by different sizes of the openings. The openings are intended for holding fastening elements, especially hooks, by the choice of a certain opening the length of the tensioning element also being optimum. The openings are formed in the production process by the tensioning element 1 being divided in two in the shape of a grid during production.

In the plane of the openings the tensioning element has a width B which is determined by the given requirements for strength and by the choice of the materials used. This also applies to the thickness of the tensioning element which is given perpendicularly to the width. The width and thickness can randomly have the same dimensions, but they are generally different.

The tensioning element consists of polyurethane, PVC, synthetic rubber, natural rubber, leather, synthetic leather, nonwovens, yarn groups, yarns, synthetic yarns, natural fibers, high-performance fibers, textiles, woven steel, stranded yarn, knit steel, steel fibers, aluminum fibers, braided textiles, textile fabrics or of a combination of these materials. Here elastic, semielastic or inelastic materials in any combination are processed.

The tensioning element can be reinforced with stranded steel to increase the resistance to cutting and tearing. Furthermore materials of aramid fibers, PE fibers, steel fibers, aluminum fibers or high-performance fibers are used as cut-proof reinforcements, protection being excellent for securing sharp-edged items.

The openings are used to attach items to objects which have some hook-like formation. This can be for example the case for the thumb screw of a bicycle in that the tensioning element is guided from thumb screw to thumb screw over the item to be secured on the baggage carrier of the bicycle and is hooked in the wings of the respective thumb screws by means of one of the openings with the desired, freely selectable tensioning force.

Tensioning elements of the described type are produced to be continuous and are generally available as roll material; this is especially advantageous. The required length can be obtained from case to case by simple cutting.

The tensioning element can however also have fasteners such as for example a hook or a hook-like formation, with which the fastener is selectively part of the tensioning element.

Advantageously any length of the tensioning element can be selected by attaching at least one hook.

But there can also be fasteners in the tensioning element attached immovably at certain locations by their being injected onto the tensioning element directly as an injection-molded part, for example, during manufacture.

FIG. 1B shows a view of a tensioning element as claimed in the invention with a second looped-through tensioning element.

An identical, second tensioning element 1′ with openings 2′ is looped through the opening 2 of the tensioning element 1. In this way the tensioning elements 1, 1′ can be crossed at these points and then remain without additional plastic parts or plastic rings in the correct position without slipping down on the transported article in order to hold it.

A tensioning element 1 with at least one second, similar, preferably identical tensioning element 1′ can be made as a tie-down strap, as an octopus strap, as a baggage net, safety net, retaining net or the like.

Thus for example several tensioning elements 1, 1′ with the same or different grid lengths form a net of any shape with reference to the dimensions, especially to the dimension of the mesh width, by repeatedly looping through the openings 2, 2′ of other tensioning elements.

The grid arrangement and the diameter of the openings 2, 2′ can be arranged such that after looping through, the tensioning elements cannot move against one another even without sewing.

The tear resistance of the tensioning elements is such that the resistance at the crossing points satisfies the resistance of the TUeV standard not only of the light (540 N) and the medium (685 N), but also the heavy (1225 N) tensioning element. The tear resistance of the elements can also be made such that it can be used as baggage netting in cars, trucks, and aircraft. Likewise it can be used as a geological retaining net for safeguarding against falling rock, detritus, earth and snow. For loads starting at 10 daN fabricated from an elastic and/or semielastic material and in any case semielastic and/or inelastic material for the transverse element or a combination of these materials, these tensioning elements are used preferably to secure loads.

FIG. 2 shows a tensioning element as an octopus strap for light loads. A bag 4 is attached to the baggage carrier 3 of a bicycle by means of the tensioning element which consists of 3 parts 6, 6′ and 6″. The third part 6″ has been looped through the openings 2, 2′. The individual parts are made with hooks (not shown) on their ends and are attached by means of the hooks to the baggage carrier.

Since parts 6, 6′, 6″ have a predefined grid, the connection of the tensioning elements of individual parts need not necessarily take place at one point, but depending on the size of the volume they can be connected by the user at the desired location. This yields enormous flexibility for the user in securing the transported material at the correct location.

FIG. 3 shows a first embodiment of a tensioning element with two attached hooks. In the openings 2, 2′ hooks 7, 7′ are attached, and they can be inserted again at any time into any opening, by which a length of the tensioning element which is ideal depending on the existing grid of openings can be achieved. The hook is made especially user-friendly by its not having 2 to 3 times the thickness, by which the transported article can be easily attached.

The individual divided tensioning elements can be joined together in manufacture and can be provided with hooks on the end for the user to form a practical octopus strap.

FIG. 4 shows a hook in a front view and a side view. The hook can be as a stamping, wound from wire or injected from plastic [sic]. It is made such that it can be secured without its falling out of the attachment. The hook can be secured and removed with the corresponding tensioning of the new, elastic, divided tensioning element. But in the untensioned state it cannot fall out and become lost.

FIG. 5 shows a second embodiment of several tensioning elements as a baggage net for heavy loads. This net can be used in cars, trucks, or aircraft to secure a load. The individual elements are produced with a tear resistance such that the corresponding standards are satisfied.

FIG. 6 shows a third embodiment of several tensioning elements as a cargo retaining net. Such a net can be used with or without pallets for securing cargo.

FIG. 7 shows a fourth embodiment of several tensioning elements as a shock-absorbing net. Such a net is used for rock, earth, detritus and other materials as a protective net.

If requirements are higher, with reinforcement to prevent cutting, a shock-absorbing net can be obtained which is used for safety in sporting events such as ski races and auto races.

FIG. 8 shows a cross section of a tensioning element with reinforcement of stranded steel. Besides stranded steel, this reinforcement has a plurality of high-performance fibers 8, by which reinforcement for prevention of cutting is achieved.

This reinforcement can consist of aramid fibers, PE fibers, steel fibers, aluminum or high-performance fibers, and when made as a net, can be used to secure sharp-edged articles. Applications include rock fall, avalanches, soil masses, individuals, for crash protection, impact protection, barriers and denial of any type.

The user can configure the individual, divided elastic tensioning elements into a net by looping tensioning elements through one another. The net is formed by the individual tensioning elements during manufacture, edged by another tensioning element and provided with hooks. This yields a practical, elastic baggage net on which the same hooks are also secured again.

The same net from formed products can also be produced from materials which satisfy the requirements and standards of different types of transportation such as cars, trucks, aircraft, ships, or rail.

With the tensioning element as claimed in the invention loads can be attached anywhere; bicycle, scooter, motorcycle, car, van, truck, aircraft, etc.

1. Tensioning element for securing loads, wherein it is made, divided in a grid, with openings, in the manner of cable, belt, strap or string, the openings having side elements and transverse elements, that the side elements consist of an elastic and/or semielastic material and the transverse elements consist of an inelastic and/or semielastic material and that the openings are designed to accommodate a fastener and for looping through at least one other identical or similar tensioning element.

2. Tensioning element as claimed in claim 1, wherein the fastener is a hook or hook-like formation.

3. Tensioning element as claimed in claim 1, wherein the fastener is optionally part of the tensioning element.

4. Tensioning element as claimed in claim 2, wherein any length of the tensioning element can be selected by attaching at least one hook.

5. Tensioning element as claimed in claim 2, wherein the tensioning element has at least one hook or a hook-like formation which is present injected on as an injection-molded part.

6. Tensioning element as claimed in claim 1, wherein the transverse element has the same or different width and thickness.

7. Tensioning element as claimed in claim 1, wherein it consists of polyurethane, PVC, synthetic rubber, natural rubber, leather, synthetic leather, nonwovens, yarn groups, yarns, synthetic yarns, natural fibers, high-performance fibers, textiles, woven steel, stranded yarn, knit steel, steel fibers, aluminum fibers, braided textiles, textile fabrics or of a combination of these materials.

8. Tensioning element as claimed in claim 1, wherein it is reinforced with steel strands for enhancing the resistance to cutting and tearing.

9. Tensioning element as claimed in claim 1, wherein it has cut-proof reinforcement of aramid fibers, PE fibers, steel fibers, aluminum or high-performance fibers.

10. Tensioning element as claimed in claim 1, wherein it forms an octopus strap with at least one second, similar, preferably identical tensioning element by looping through the openings of the first tensioning element.

11. Tensioning element as claimed in claim 1, wherein several tensioning elements 1, 1′ with the same or different grid lengths form a net by repeatedly looping through the openings of other tensioning elements.

12. Tensioning element as claimed claim 10, wherein the grid arrangement of the openings and the diameter of the openings are such that after looping through in the untensioned or tensioned state the tensioning elements cannot move against one another in the tensioned state even without sewing.

13. Tensioning element as claimed in claim 1, wherein is designed for loads starting at 10 daN from an elastic, semielastic or inelastic material or a combination of these materials and is used to secure loads.

14. Tensioning element as claimed in claim 1, wherein it is designed as a load net for trucks or as a cargo retaining net in aircraft and ships.

15. Tensioning element as claimed in claim 1, wherein it is made as a receiving net.

16. Tensioning element as claimed in claim 1, wherein it is present as roll material.
